(19) United States
(12) Patent Application Publication
(10) Pub. No.: US 2012/0164881 A1
(43) Pub. Date: Jun. 28, 2012

(54) SHIELDED CONNECTOR

(75) Inventor: Ted Ju, Keelung (TW)

(73) Assignee: LOTES CO., LTD., Keelung City (TW)

(21) Appl. No.: 13/109,692

(22) Filed: May 17, 2011

(30) Foreign Application Priority Data
Dec. 22, 2010 (TW) 201020675701.2

(51) Int. Cl. H01R 13/648

(52) U.S. Cl. 439/607.01

(57) ABSTRACT

A shielded connector includes: a seat, including an insulating body having a plurality of receiving slots, in which an intermediate layer is disposed on at least a part of an inner surface of the receiving slot, a shield is disposed outside the intermediate layer, and an isolator is disposed outside the shield, at least one conductive body disposed outside the receiving slots and connected to the shields, and at least one lead-out portion electrically connected to the conductive body; and a plurality of conductive terminals, correspondingly accommodated in the receiving slot, each including a contact portion exposed at one side of the seat, a body portion extending from the other end of the contact portion into the receiving slot, and a connecting section extending from the body portion and exposed at the other side of the seat.

### CROSS-REFERENCE TO RELATED APPLICATIONS

This non-provisional application claims priority under 35 U.S.C. §119(a) on Patent Application No. 201020675701.2 filed in China, P.R.C. on Dec. 22, 2010, the entire contents of which are hereby incorporated by reference.

### FIELD OF THE INVENTION

The present invention relates to a shielded connector, and more particularly to a shielded connector capable of avoiding shield cracking during soldering.

### BACKGROUND OF THE INVENTION

To solve the problem of electromagnetic interference during signal transmission, a shielded connector has been proposed in the prior art, which electrically connects a mating electronic component to a motherboard and includes a seat and a plurality of conductive terminals accommodated in the seat.

The seat includes: an insulating body, having a plurality of receiving slots, in which a shield is disposed on an inner surface of each of the receiving slots, an isolator is disposed outside the shield, and the isolator is used for electrically insulating the conductive terminal from the shield; a conductive body, formed on a bottom surface of the insulating body, and communicating the shields; and two lead-out portions, located on the bottom surface of the insulating body adjacent to the motherboard, and for electrically connecting the conductive body to the motherboard.

The conductive terminals are correspondingly accommodated in the receiving slots. Each of the conductive terminal includes: a contact portion exposed at one side of the seat and in electrical contact with the mating electronic component, a body portion extending from the contact portion into the receiving slot, and a conductive portion extending from the body portion, exposed at the other side of the seat and electrically conducted with the motherboard.

Since the shield is disposed in each of the receiving slots, the problem of electromagnetic interference during signal transmission can be solved. However, since the expansion coefficient of the insulating body is much greater than that of the shield, the degree of expansion of the insulating body is much greater than that of the shield in the process of heating and soldering the shielded connector in a reflow oven, so that the shield easily cracks, thus affecting the shielding effect for the conductive terminal.

In view of the above, the shielded connector in the prior art has the defect that the shield easily cracks during soldering.

Therefore, a heretofore unaddressed need exists in the art to address the aforementioned deficiencies and inadequacies.

### SUMMARY OF THE INVENTION

Accordingly, the present invention is directed to a shielded connector capable of avoiding shield cracking during soldering.

In one aspect of the present invention, a shielded connector is provided. The shielded connector of the present invention includes: a seat, including an insulating body having a plurality of receiving slots, in which an intermediate layer is disposed on at least a part of an inner surface of the receiving slot, a shield is disposed outside the intermediate layer, and an isolator is disposed outside the shield, at least one conductive body disposed outside the receiving slots and connected to the shields, and at least one lead-out portion disposed adjacent to the motherboard and electrically connecting the conductive body to the motherboard; and a plurality of conductive terminals, accommodated in the receiving slots, each including a contact portion exposed at one side of the seat and having one end in electrical contact with the mating electronic component, a body portion extending from the other end of the contact portion into the receiving slot, and a connecting section extending from the body portion, exposed at the other side of the seat and conducted with the motherboard.

As compared with the prior art, in the shielded connector of the present invention, since the intermediate layer is disposed between the insulating body and the shield, the difference between the degrees of expansion of the insulating body and the shield can be moderated, thus preventing the shield from cracking in the process of heating and soldering the shielded connector.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a schematic view of a shielded connector according to a first embodiment of the present invention fitted to a motherboard;

FIG. 2 is a schematic partial sectional view of the shielded connector according to the first embodiment of the present invention taken from another angle of view;

FIG. 3 is a schematic plan view of the shielded connector according to the first embodiment of the present invention; and

FIG. 4 is a schematic partial sectional view of a second embodiment of the shielded connector of the present invention.

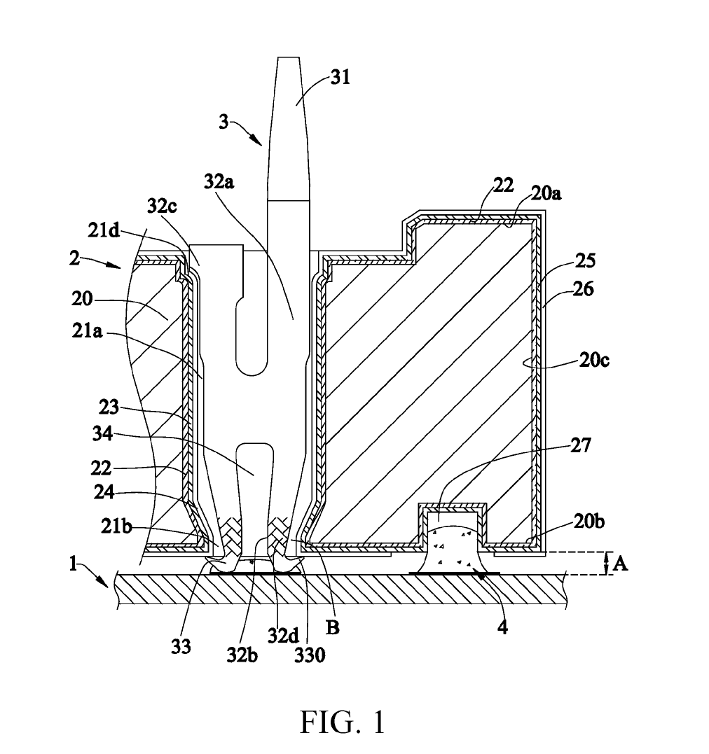

### LIST OF REFERENCE NUMERALS IN FIGS. 1-4

| | | |
|---|---|---|
| Motherboard 1 | | |
| Seat 2 | | |
| Insulating body 20 | Upper surface 20a | Lower surface 20b |
| Side surface 20c | Intermediate layer 22 | Shield 23 |
| Isolator 24 | Conductive body 25 | Spacer 26 |
| Lead-out portion 27 | | |
| Receiving slot 21 | Wide section 21a | Narrow section 21b |
| Bypass portion 21c | Step region 21d | |
| Conductive terminal 3 | Contact portion 31 | Connecting section 33 |
| Body portion 32 | Less-wide section 32a | Shrinking section 32b |
| Urging region 32c | Insulator 32d | groove 34 |
| Urging portion 330 | | |
| Solder 4 | | |

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The shielded connector of the present invention is further described in detail below with reference to the accompanying drawings and specific embodiments.

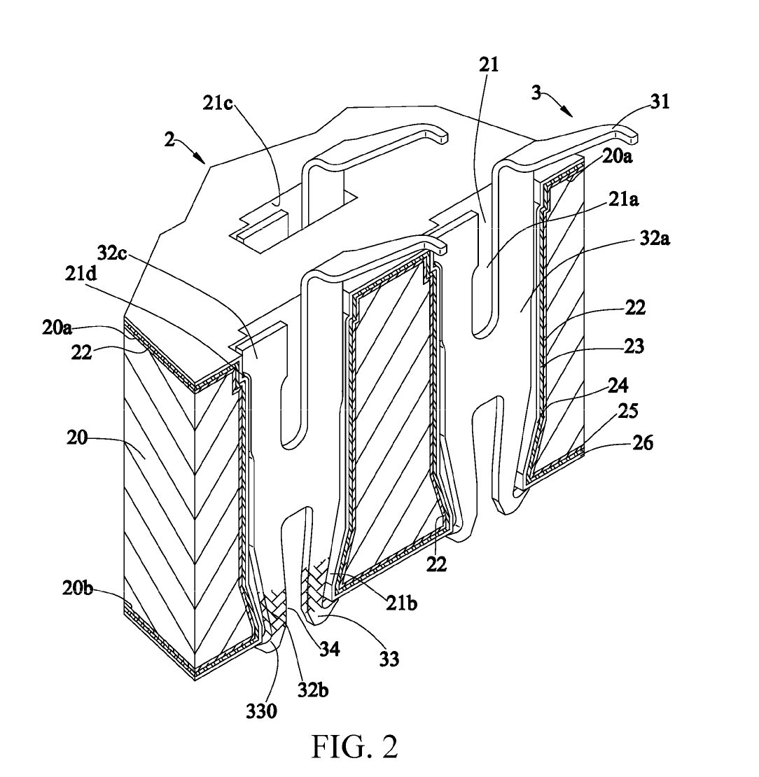

Referring to FIGS. 1 and 2, the shielded connector of one embodiment of the present invention connects a mating electronic component (not shown) to a motherboard 1 and includes a seat 2, a plurality of conductive terminals 3 accommodated in the seat 2, and a plurality of solders 4 disposed on the seat 2.

The seat 2 includes an insulating body 20. The insulating body 20 has an upper surface 20a adjacent to the mating electronic component, a lower surface 20b opposite to the upper surface 20a and adjacent to the motherboard 1, and a plurality of side surfaces 20c connecting the upper surface 20a and the lower surface 20b.

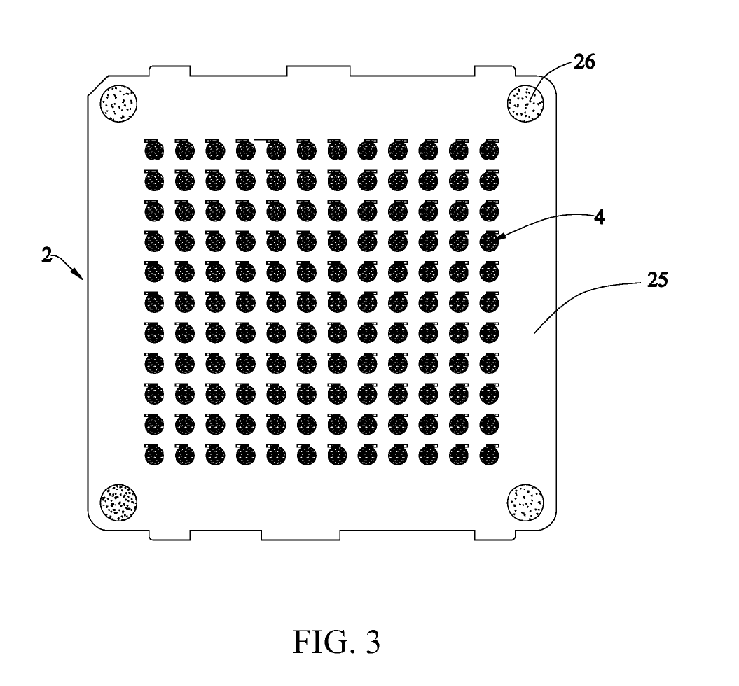

Referring to FIGS. 1 and 3, the insulating body 20 further includes a plurality of receiving slots 21 formed through the upper surface 20a and the lower surface 20b, an intermediate layer 22 is disposed on an inner surface of each receiving slot 21, a shield 23 is disposed outside the intermediate layer 22, an isolator 24 is disposed on the shield 23, a conductive body 25 is disposed on a surface of the insulating body 20 and connected to the shields 23, a spacer 26 is disposed on the conductive body 25, and four lead-out portions 27 are located at corners of the seat 2 (the lead-out portions 27 may be further disposed on a central axis of the seat 2), in which the lead-out portions 27 are disposed adjacent to the motherboard 1 and connect the conductive body 25 to the motherboard 1.

Each receiving slot 21 may be divided into a non-interference section (not labeled) and a scratched section (not labeled) in communication with the non-interference section according to whether the section is scratched by the conductive terminal 3. The isolator 24 of the scratched section is easily scraped or even peeled off in the process of mounting the conductive terminal 3 into the receiving slot 21, and then the shield 23 of the scratched section is exposed to the outside. In particular, each receiving slot 21 includes a wide section 21a (corresponding to the non-interference section) adjacent to the upper surface 20a, a narrow section 21b (corresponding to the scratched section) adjacent to the lower surface 20b and in communication with the wide section 21a, and a bypass portion 21c laterally communicating the wide section 21a and the narrow section 21b and formed through the seat 2. The wide section 21a is laterally recessed at a position adjacent to the upper surface 20a to form a step region 21d.

The expansion coefficient of the intermediate layer 22 is between the expansion coefficient of the insulating body 20 and the expansion coefficient of the shield 23, so that the difference between the degrees of expansion of the insulating body 20 and the shield 23 can be moderated, thus preventing the shield 23 from cracking to affect the shielding effect for the conductive terminal 3 in the process of soldering the shielded connector to the motherboard 1 due to the great difference between the degrees of expansion of the shield 23 and the insulating body 20. The material of the intermediate layer 22 is preferably Al, Mg, Zn, Sn or an alloy thereof, the material of the insulating body 20 is a liquid crystal polymer (LCP), and the material of the shield 23 is preferably steel, Ni or an alloy thereof.

The intermediate layer 22 may be further disposed between the insulating body 20 and the conductive body 25, so as to prevent the conductive body 25 from cracking in the process of soldering the shielded connector to the motherboard 1 due to the great difference between the degrees of expansion of the conductive body 25 and the insulating body 20.

The shield 23 is disposed on the inner surface of the receiving slot 21.

The conductive body 25 is arranged all over the upper surface 20a and the side surfaces 20c and is arranged on a part of the lower surface 20b. The conductive body 25 arranged on the lower surface 20b is at an interval A from the motherboard 1.

The shield 23 and the conductive body 25 are integrally formed, and alternatively, the shield 23 and the conductive body 25 may also be separately formed.

The isolator 24 is an insulating film for electrically insulating the conductive terminal 3 from the shield 23. The isolator 24 is formed outside the shield 23 by a physical-plating process (for example, vacuum evaporation or vacuum sputtering), coating, immersing or spraying.

The spacer 26 is an insulating film for electrically insulating the seat 2 from the outside and especially for electrically insulating the mating electronic component from the seat 2 and electrically insulating the motherboard 1 from the seat 2. The spacer 26 is arranged all over the conductive body 25 by a physical-plating process (for example, vacuum evaporation or vacuum sputtering), coating, immersing or spraying.

The isolator 24 and the spacer 26 are integrally formed, and alternatively, the isolator 24 and the spacer 26 may also be separately formed.

The spacer 26 is disposed outside the conductive body 25 arranged on the upper surface 20a so as to avoid short circuit between the mating electronic component and the conductive body 25 arranged on the upper surface 20a. The spacer 26 is disposed outside the conductive body 25 arranged on the lower surface 20b so as to avoid short circuit between the motherboard 1 and the conductive body 25 arranged on the lower surface 20b.

Referring to FIG. 1, the lead-out portions 27 are recessed inwards from the bottom surface of the seat 2 and each includes a conductive layer located on an inner surface thereof. The lead-out portions 27 and the motherboard 1 are electrically connected.

The solders 4 are correspondingly accommodated in the lead-out portions 27 and planted on the conductive terminals 3. The solders 4 are partially exposed outside the bottom surface of the seat 2, and correspondingly solder the conductive terminals 3 and the lead-out portions 27 to the motherboard 1.

The conductive terminals 3 are correspondingly accommodated in the receiving slots 21 and each includes a contact portion 31 exposed at one side of the seat 2 and in electrical contact with the mating electronic component, a body portion 32 extending from the contact portion 31 into the receiving slot 21, and a connecting section 33 extending from the body portion 32, exposed at the other side of the seat 2, and electrically conducted with the motherboard 1.

The body portion 32 is plate shaped and is loosely accommodated in the receiving slot 21. The body portion 32 includes a less-wide section 32a located in the wide section 21a and having a width smaller than that of the wide section 21a. The less-wide section 32a and the wide section 21a are in clearance fit, and in the process of mounting the conductive terminal 3 into the receiving slot 21, the less-wide section 32a and the wide section 21a do not interfere with each other. The less-wide section 32a has an urging region 32c adjacent to the contact portion 31, and the urging region 32c is fitted to the step region 21d to limit downward movement of the conductive terminal 3.

The body portion 32 further includes a shrinking section 32b extending from the less-wide section 32a and located in the narrow section 21b. In the process of mounting the conductive terminal 3 into the receiving slot 21, the narrow section 21b is scratched by the connecting section 33, and the isolator 24 outside the shield 23 is easily scraped or peeled off to partially expose the shield 23, so the shrinking section 32b located in the narrow section 21b is the portion of the body portion 32 at a high risk of being in short circuit with the shield 23, and for the convenience of illustration, this portion is defined to be a high risk section of short circuit. To solve the problem that the shrinking section 32b and the narrow section 21b easily contact with each other to cause short circuit, in this embodiment, the width of the shrinking section 32b is designed to be smaller than that of the narrow section 21b, so that in the process of mounting the conductive terminal 3 into the receiving slot 21, the shrinking section 32b and the narrow section 21b do not interfere with each other, and after the conductive terminal 3 and the receiving slot 21 are finally fitted to each other, a clearance B exits between the shrinking section 32b and the narrow section 21b. The existence of the clearance B prevents the isolator 24 from being scraped or peeled off to cause the uncovered shield 23 contacting the shrinking section 32b, thus avoiding short circuit between the uncovered shield 23 and the conductive terminal 3. Alternatively, an insulator 32d may be further formed on the shrinking section 32b to further avoid short circuit between the uncovered shield 23 and the conductive terminal 3. It should be noted that, the clearance fit of the scratched section (corresponding to the shrinking section 32b) and the narrow section 21b is a measure for solving the problem of short circuit between the scratched section and the conductive terminal 3, the provision of the insulator 32d on the high risk section of short circuit of the body portion 32 is another measure for solving problem of short circuit between the scratched section and the conductive terminal 3, and the two measures may be used separately or together.

The connecting section 33 includes two urging portions 330 having a groove 34 therebetween, and the groove 34 extends into the less-wide section 32a to provide a space for deformation of the connecting section 33, thus improving the elasticity of the connecting section 33.

The width of the connecting section 33 is smaller than that of the wide section 21a, so that in the process of mounting the conductive terminal 3 into the receiving slot 21, the connecting section 33 and the wide section 21a do not interfere with each other. The width of the connecting section 33 is greater than that of the narrow section 21b, so that in the process of mounting the conductive terminal 3 into the receiving slot 21, the connecting section 33 is in interference fit with the narrow section 21b and may scratch the narrow section 21b, and after the conductive terminal 3 and the receiving slot 21 are finally fitted to each other, the connecting section 33 urges against the bottom surface of the seat 2.

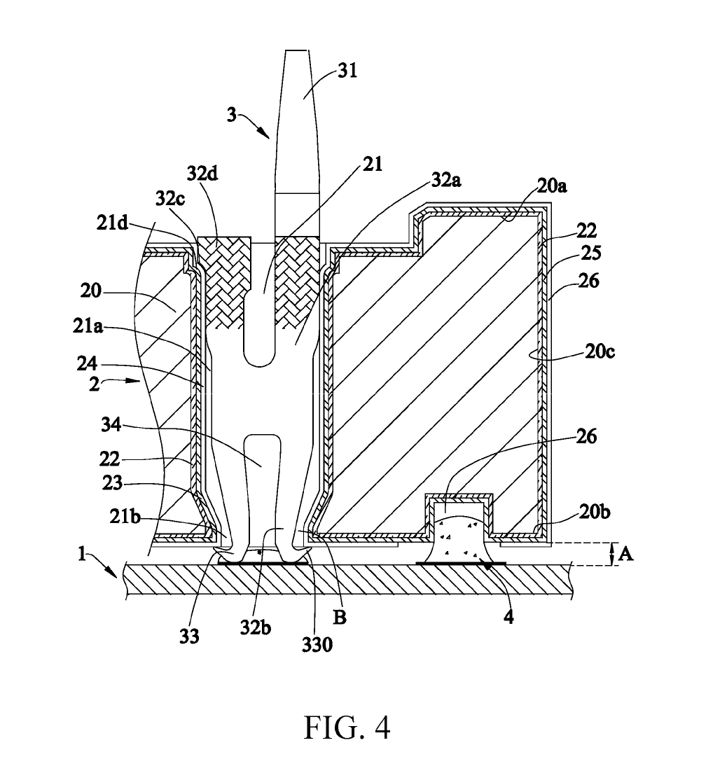

FIG. 4 illustrates a second embodiment of the present invention, which differs from the first embodiment in terms of that the less-wide section 32a may also be in contact with the wide section 21a. This design has a risk that: in the process of soldering the shielded connector to the motherboard 1, if there is a large difference between the expansion coefficients of the insulating body 20, the shield 23 and the isolator 24, the isolator 24 easily cracks so that a part of the shield 23 is uncovered and in contact with the less-wide section 32a, which causes short circuit between the conductive terminal 3 and the shield 23. In other words, the contact region between the body portion 32 and the receiving slot 21 is a region at a high risk of being in short circuit with the shield 23, and for the convenience of illustration, this region is defined to be a high risk section of short circuit. To solve the problem of short circuit between the conductive terminal 3 and the shield 23, in this embodiment, the insulator 32d is disposed in the high risk section of short circuit of the body portion 32 to electrically insulate the partially uncovered shield 23 from the conductive terminal 3, so as to avoid short circuit between the two.

In other embodiments, the insulator 32d is arranged all over the body portion 32.

In other embodiments, the urging region 32c is formed on the less-wide section 32a at a position adjacent to the shrinking section 32b, and accordingly, the step region 21d is disposed on the wide section 21a at a position adjacent to the narrow section 21b; or the urging region 32c is formed on the body portion 32 at a position adjacent to the contact portion 31, and the urging region 32c directly urges against the top surface of the seat 2. All of the above configurations aim to prevent the conductive terminal 3 from falling down from the receiving slot 21.

In other embodiments, the conductive terminals 3 include a plurality of signal terminals (not labeled) and a plurality of power supply terminals (not labeled), and correspondingly, the receiving slots 21 include a plurality of signal terminal slots (not labeled) for accommodating the signal terminals and a plurality of power supply terminal slots (not labeled) for accommodating the power supply terminals, and in order to avoid short circuit between the power supply terminal and the conductive body 25 due to breakdown of the isolator 24 in the power supply terminal slot, no shield 23 is arranged on the inner surface of the power supply terminal slot, and accordingly, the insulator 32d may be not disposed on the body portion 32 of the power supply terminal.

In other embodiments, the shield 23 may also be a metal sheet, or the shield 23 may be formed on a part of the inner surface of the receiving slot 21 instead of covering the entire inner surface of the receiving slot 21. Numerous configurations can be adopted, which will not be enumerated one by one herein.

In other embodiments, the conductive body 25 is disposed in the seat 2, or the conductive body 25 is disposed only on the lower surface 20b, or the conductive body 25 is disposed on the upper surface 20a and in the seat 2, or the conductive body 25 is disposed on the side surfaces 20c and in the seat 2, or the shields 23 in each row of the receiving slots 21 share one conductive body 25, as long as the conductive body 25 communicates the shields 23 and is conducted with the lead-out portion 27. Numerous configurations can be adopted, which will not be enumerated one by one herein.

In other embodiments, the interval A between the conductive body 25 arranged on the lower surface 20b and the motherboard 1 may be formed by a boss (not shown) projecting from the bottom of the insulating body 20. In this case, the spacer 26 is not required to be arranged outside the conductive body 25 arranged on the lower surface 20b.

In other embodiments, the conductive body 25 is a conductive sheet or a conductive trace.

In other embodiments, the isolator 24 is a plastic member or an insulating adhesive; or the isolator 24 is not disposed outside the shield 23, but short circuit between the conductive terminal 3 and the shield 23 is avoided by fitting of the conductive terminal 3 to the insulating body 20.

In other embodiments, the spacer 26 is only disposed outside the conductive body 25 on the lower surface 20b and the spacer 26 is not disposed outside the conductive body 25 arranged on the side surfaces 20c and the upper surface 20a, or the spacer 26 is disposed outside the conductive body 25 arranged on the upper surface 20a and the lower surface 20b, or the spacer 26 is an independently formed plastic member or rubber sheet and is located between the motherboard 1 and the conductive body 25 arranged on the lower surface 20b. All of the above configurations aim to avoid short circuit between the conductive body 25 and the adjacent motherboard 1, the mating electronic component and the like. Numerous configurations can be adopted, which will not be enumerated one by one herein.

In other embodiments, the lead-out portion 27 is recessed from the side surfaces 20c, or the lead-out portion 27 is formed on the side surfaces 20c and the lead-out portion 27 is adjacent to the motherboard 1.

In other embodiments, the number of the lead-out portion 27 may also be 1, 2, 3 or more, or one lead-out portion 27 may be arranged every other rows of the receiving slots 21. Numerous configurations can be adopted, which will not be enumerated one by one herein. It should be noted that, the lead-out portions 27 need to be arranged evenly to ensure consistent interference shielding for every conductive terminal 3, thus improving the shielding effect.

In other embodiments, the lead-out portion 27 may be an independently formed component, and fitted to the shielded connector to conduct the conductive body 25 with the motherboard 1.

In other embodiments, the conductive terminal 3 just has one urging portion 330, and in this case, a deflection section (not shown) is disposed on the body portion 32 to provide elastic deformation of the connecting section 33 in the process of fitting the connecting section 33 to the receiving slot 21.

In other embodiments, the bypass portion 21c may be disposed only corresponding to the wide section 21a, or the bypass portion 21c may be disposed only corresponding to the narrow section 21b, or the bypass portion 21c may be disposed corresponding to a part of the wide section 21a and a part of the narrow section 21b, and the bypass portion 21c may not be formed through the seat 2. In all of the above configurations, the provision of the bypass portion 21c aims to reduce the contact area of the body portion 32 of the conductive terminal 3 and the receiving slot 21, so as to reduce the capacitance effect therebetween. Numerous configurations can be adopted, which will not be enumerated one by one herein.

The assembling process of the shielded connector of one embodiment of the present invention is described as follows.

The conductive terminal 3 is aligned with the receiving slot 21, and the conductive terminal 3 is pushed, so that the connecting section 33 passes through the wide section 21a without interference, and then, the connecting section 33 passes through the narrow section 21b and scratches the narrow section 21b, and finally passes out of the receiving slot 21 and urges against the bottom surface of the seat 2; meanwhile, the less-wide section 32a enters the wide section 21a without interference and the urging region 32c finally abuts against the step region 21d, the shrinking section 32b enters the narrow section 21b without interference and is spaced from the narrow section 21b by the clearance B, and the body portion 32 is partially exposed outside the bypass portion 21c.

The present invention, among other things, has the following beneficial effects.

(1) Since the intermediate layer 22 is disposed between the insulating body 20 and the shield 23, and the expansion coefficient of the intermediate layer 22 is between those of the insulating body 20 and the shield 23, the shield 23 can be prevented from cracking in the process of soldering the shielded connector to the motherboard 1 due to the great difference between the degrees of expansion of the shield 23 and the insulating body 20.

(2) Since the clearance B exists between the scratched narrow section 21b of the receiving slot 21 and the shrinking section 32b of the conductive terminal 3, in the process of mounting the conductive terminal 3 into the receiving slot 21, the shield 23 exposed after the isolator 24 is scraped or even peeled off will not contact the body portion 32 of the conductive terminal 3, thus avoiding short circuit between the conductive terminal 3 and the shield 23.

(3) Since the insulator 32d is arranged on the high risk section of short circuit on the body portion 32, in the process of mounting the conductive terminal 3 into the receiving slot 21, the shield 23 exposed after the isolator 24 is scraped or even peeled off can be electrically insulated from the body portion 32 by the insulator 32d, thus avoiding short circuit between the shield 23 and the conductive terminal 3; likewise, in the process of soldering the shielded connector to the motherboard 1, the partially uncovered shield 23 caused by cracking of the isolator 24 due to the large difference between the expansion coefficients of the insulating body 20, the shield 23 and the isolator 24 can also be electrically insulated from the conductive terminal by the insulator 32d, thus avoiding the short circuit between the two.

(4) Since the lead-out portion 27 is recessed towards the inside of the seat 2, the lead-out portion 27 can accommodate a large amount of solders 4, so as to achieve a good soldering effect and prevent solder cracking

(5) Since the receiving slot 21 has a bypass portion 21c, the contact area of the body portion 32 and the receiving slot 21 is reduced, which reduces the capacitance effect.

(6) Since the lead-out portions 27 are uniformly distributed on the seat 2, consistent interference shielding for every conductive terminal 3 is achieved, which can ensure the uniformity of signal transmission and improve the shielding effect.

Although the preferred embodiments of the present invention are described in detail above, they are not intended to limit the scope of the present invention. Any equivalent variations or modifications made without departing from the spirit of the present invention shall fall within the scope of the present invention.

What is claimed is:

1. A shielded connector, connecting a mating electronic component to a motherboard, comprising:
a seat, having an insulating body having a plurality of receiving slots, wherein an intermediate layer is disposed on at least a part of an inner surface of the receiving slot, a shield is disposed outside the intermediate layer, and an isolator is disposed outside the shield, at least one conductive body disposed outside the receiving slots and connected to the shields, and at least one lead-out portion disposed adjacent to the motherboard and electrically connecting the conductive body to the motherboard; and
a plurality of conductive terminals, correspondingly accommodated in the receiving slots, each having a contact portion exposed at one side of the seat and in electrical contact with the mating electronic component, a body portion extending from the contact portion into the receiving slot, and a connecting section extending from the body portion, exposed at the other side of the seat and conducted with the motherboard.

2. The shielded connector according to claim 1, wherein an expansion coefficient of the intermediate layer is between an expansion coefficient of the insulating body and an expansion coefficient of the shield.

3. The shielded connector according to claim 1, wherein the material of the intermediate layer is Al, Mg, Zn, Sn or an alloy thereof.

4. The shielded connector according to claim 1, wherein the intermediate layer is further disposed between the insulating body and the conductive body.

5. The shielded connector according to claim 1, wherein the material of the shield is steel, Ni or an alloy thereof.

6. The shielded connector according to claim 1, wherein the material of the insulating body is a liquid crystal polymer.

7. The shielded connector according to claim 1, wherein an insulator is arranged on the body portion.

8. The shielded connector according to claim 7, wherein the body portion has at least one urging region that urges against the seat in a reverse direction of the connecting section.

9. The shielded connector according to claim 1, wherein the connecting section comprises two urging portions having a groove therebetween.

10. The shielded connector according to claim 1, wherein the receiving slot comprises a scratched section, and the body portion is in clearance fit with the scratched section.
